(19) United States
(12) Patent Application Publication
(10) Pub. No.: US 2006/0066566 A1
(43) Pub. Date: Mar. 30, 2006

(54) Method of emulating a pointing device button

(76) Inventor: Kwok Kin Law, Kowloon (HK)

Correspondence Address: Thomas E. Sisson;JACKSON WALKER L.L.P., Suite 2100, 112 E. Pecan Street, San Antonio, TX, 78205, US

(21) Appl. No.: 10/952,679

(22) Filed: Sep. 29, 2004

(51) Int. Cl. G09G 5/00

(52) U.S. Cl. 345/156

(57) ABSTRACT

A method of emulating a pointing device button press in a computer includes determining whether a key press input event is detected during a time when a pointer input event is detected, and is so performing a command to emulating a pointing device button click. The method is included in computer software product that includes a computer readable medium in which computer instructions are stored.

### BACKGROUND OF THE INVENTION

1. Field of the Invention

The present invention relates generally to the field of computer pointing devices. More particularly, the invention relates to a method of emulating a pointing device button.

2. Description of Prior Art

Typically a Graphical User Interface (GUI) computer system utilises a pointing device for moving a pointer around the screen. There are a variety of pointing devices available including a standard a mouse, a trackball, a joystick and a touchpad. Each of these pointing devices has its own advantages and disadvantages.

The standard mouse is most intuitive pointing device for controlling the pointer. It allows accurate and fine movement of the pointer around the screen. However, a mouse requires a hard flat surface for proper use and is not suitable for portable computers and mobile use. Trackball and joystick like pointing devices do not require a hard flat surface for movement and are more suitable for portable computer use. However, they are less intuitive to use and it is more difficult to master fine accurate control of the pointer. Additionally, these devices are not easily incorporated into portable computers.

The touchpad has become the standard for pointing devices on portable computers. It is compact and relatively easy to use. It is incorporated into a portable computer just below the keyboard. However, use of pointer buttons positioned next to the touchpad is difficult to master as the user's fingers must be tightly grouped together. To alleviate this many touchpad drivers let the user tap the touchpad to emulate a button press. This can also be difficult to master as a user often inadvertently lifts their finger or changes the pressure of their finger on the touchpad surface which is interpreted as a button press resulting in incorrect operation.

The aforementioned problems with touchpads cause many users to prefer to use a standard mouse with their portable computer.

### SUMMARY OF THE INVENTION

It is an object of the present invention to provide method of emulating a pointing device button that overcomes or ameliorates the aforementioned problem with touchpads or which at least provides the public with a useful alternative.

According to the invention there is provided a method of emulating a pointing device button press in a computer having connected to it a keyboard having a plurality of keys and a pointing device, the method comprising detecting a key press input event from the keyboard, detecting a pointer input event from the pointing device, determining whether the key press input event is detected during a time when the pointer input event is detected, and performing a command emulating a pointing device button press when the key press input event is detected during the time when the pointer input event is detected.

There is also provided a computer software product for use on a computer having connected to it a keyboard having a plurality of keys and a pointing device, the product comprising a computer readable medium in which computer instructions are stored, and when read by the computer cause the computer to detect a key press input event from the keyboard, detect a pointer input event from the pointing device, determine whether the key press input event is detected during a time when the pointer input event is detected, and perform a command emulating a pointing device button press when the key press input event is detected during the time when the pointer input event is detected.

Determining whether the key press input event is detected during the time when the pointer input event is detected may comprise waiting until the key press input event is detected and when the key press input event is detected determining whether the pointer input event is detected. Alternatively, it may comprise determining whether an emulation flag is in a set state or a reset state, the emulation flag being in the set state during the time when the pointer input event is detected and in the reset state otherwise.

The method may further comprise assigning a button press type to one or more keyboard keys, the button press type being one of a left button press, a right button press and a scroll press, evaluating the key press input event to determine the button press type, and wherein the command emulating a pointing device button press corresponds to the button press type.

Preferably, the pointing device is a touchpad.

Further aspects of the invention will become apparent from the following drawings and description.

### BRIEF DESCRIPTION OF THE DRAWINGS

Embodiments of the invention will now be described by way of example only and with reference to the accompanying drawings in which:

FIG. 1 illustrates a typical user hand position for pointing device operation on a portable computer using a method according to the invention,

FIG. 2 is a timeline of touchpad and keyboard key presses for a method according to the invention,

FIG. 3 is a flow chart showing the logic of a key-drive embodiment of the invention,

FIG. 4 is a flow chart showing the logic of a touchpad-drive embodiment of the invention,

FIGS. 5 and 6 are flow charts of the keyboard functions for the touchpad-drive embodiment, and

FIGS. 7 and 8 are flow charts of a software routine for implementing the invention.

### DESCRIPTION OF THE PREFERRED EMBODIMENTS

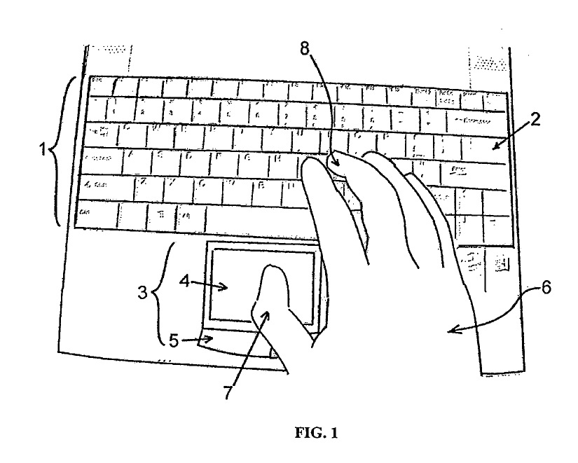

FIG. 1, illustrates a user hand position for a portable computer with touchpad pointing device 3. A software routine operates on the portable computer to monitor key presses from its keyboard 1 and pointer inputs from its touchpad surface 4. The normal touchpad buttons 5 are disabled. The software routine determines when a key press occurs while a pointer input is being received from touchpad surface 4 and if so it emulates a touchpad button click in response to the keyboard key press. This is much more convenient for the user as their hand 6 can be kept in a stretched out position with the thumb 7 controlling pointer movement via the touchpad surface 4 and finger 8 operating the keyboard keys 2 to emulate a pointer device button click.

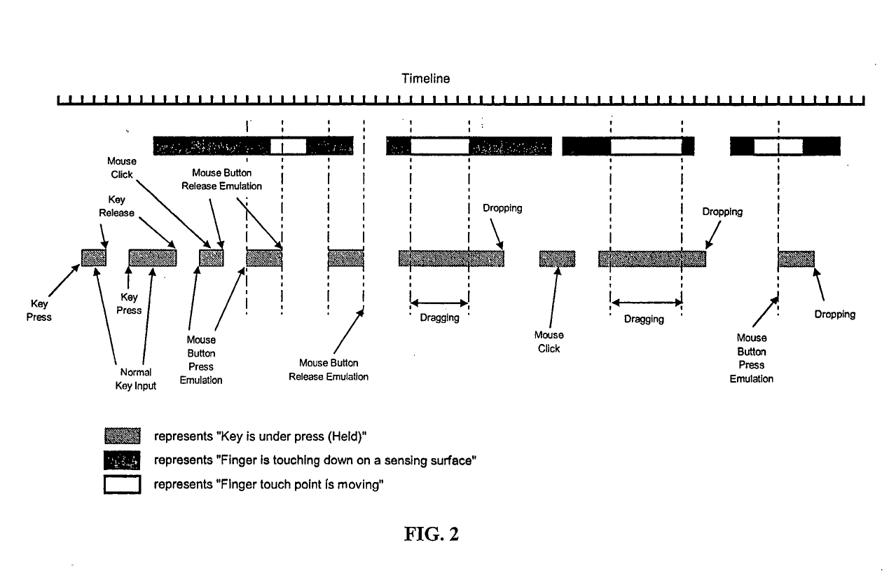

FIG. 2 shows a timeline of key 2 and touchpad 4 presses which result in a pointing device button click emulation. The emulated button click operates in the following way. If a keyboard key 2 is pressed while the thumb 7 is touching the touchpad surface 4 a command is generated that emulates a pointing device button click. The click is held (‘click and hold’) until the key 2 is released so that the user can move his or her thumb 7 on the touchpad surface 4 to perform drag and drop and scrolling functions. The thumb 7 can be lifted from the touchpad surface 4 without affecting the ‘click and hold’. The button release is emulated when the software routine detects that the keyboard key has been released.

The software determines whether a keyboard key 2 press should be a standard keyboard input or a pointing device button click by determining whether the key press occurs during a time when a touchpad pointer input event is occurring. This can be achieved via two methods.

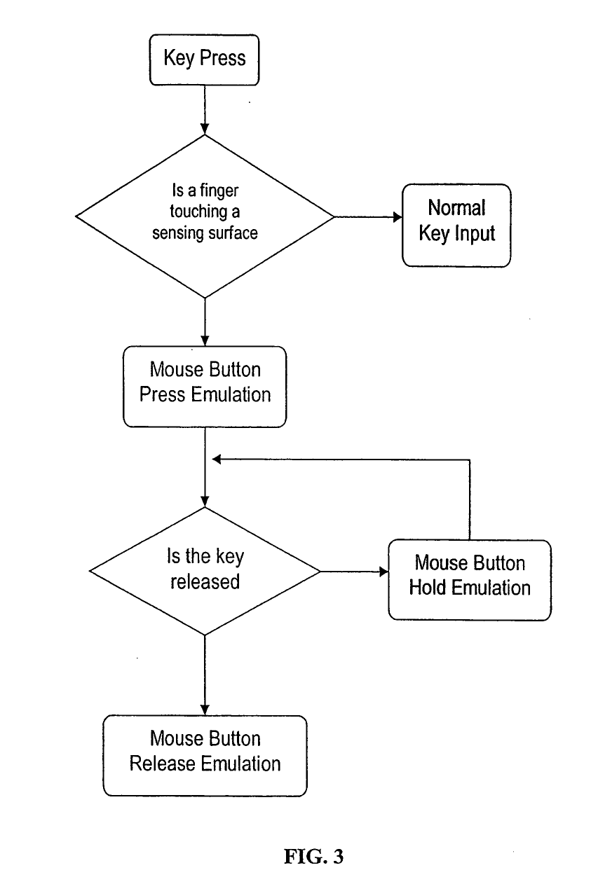

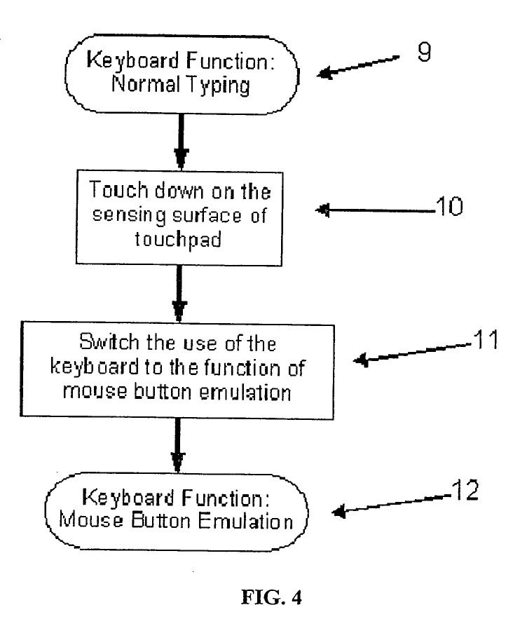

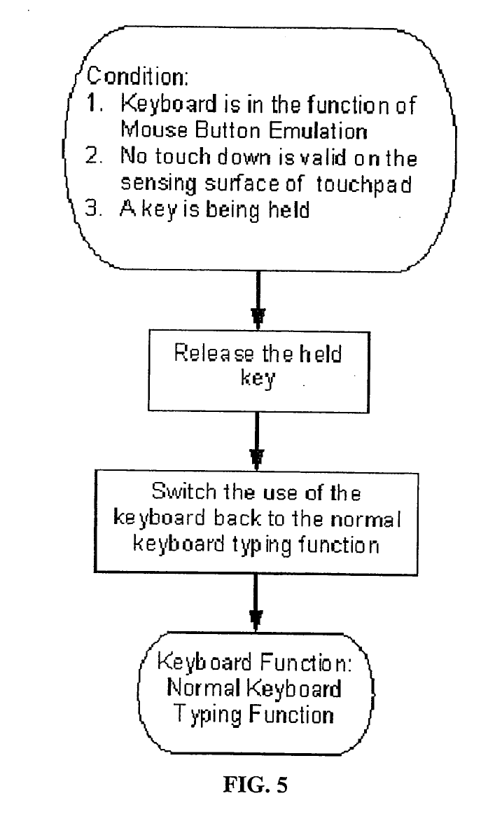

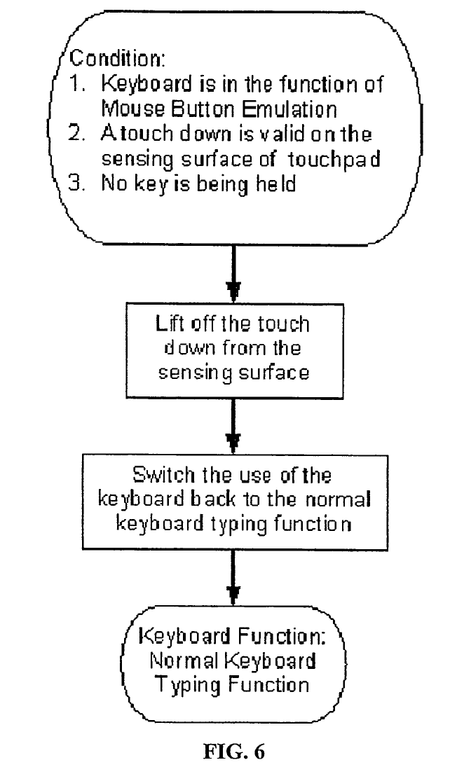

The first method is illustrated in FIG. 3. When a key 2 is pressed the software routine checks whether a finger is touching the touchpad surface 4 (a pointer input event). If it is not then the key press is passed to the computer operating system as a normal keyboard input. If the test is positive then the routine performs a command emulating a pointing device button click. The button click is maintained (click and hold) until the key 2 is released. The second method is illustrated in FIGS. 4, 5 and 6. The software routine uses a software ‘flag’ to determine whether the keyboard is being used for normal keyboard inputs or as a pointing device button. In normal use keyboard inputs are taken as normal. If an input is received from a press of the touchpad surface 4 the flag is set and the keyboard inputs switch to pointing device button functions. In this mode a keyboard key press causes a command to emulate a pointing device button click. When the press on the sensing surface 4 of the touchpad is removed and no key press is present the flag is cleared and keyboard functions return to normal.

Different keys on the keyboard can be assigned to different button types for performing different pointing device functions. For example, keys to the left side of the keyboard can be assigned to represent a left mouse button click and keys to the right side of the keyboard can be assigned to represent a right mouse button click. Keys in the middle of the keyboard; for example Y, G, H and B; can be assigned to perform various scrolling functions similar to the scroll wheel, or center button, of a standard mouse.

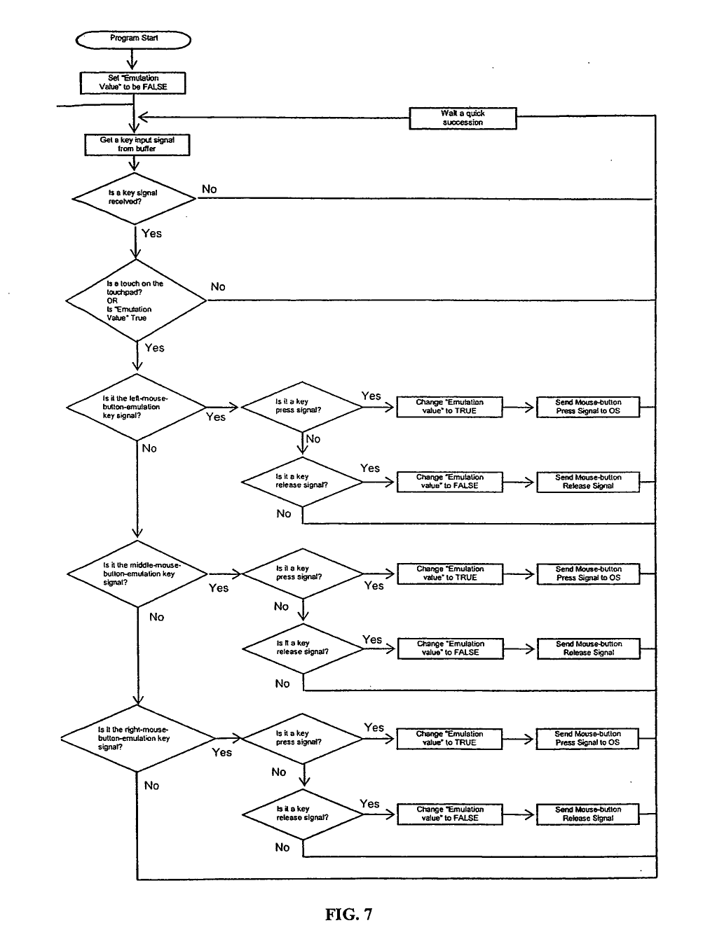

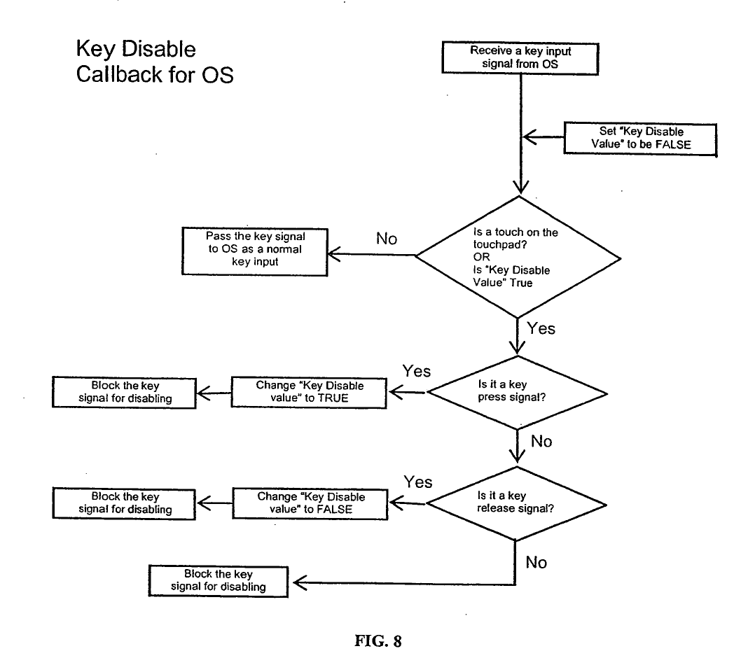

FIGS. 7 and 8 represent a flow diagram of the software routine. The software continuously runs in the background monitoring keyboard key press inputs and pointing device inputs. These are evaluated according to one of the methods of FIGS. 3; or 4, 5 and 6 and appropriate action taken.

The software comprises of two parts. The first part translates the key input event to a pointer input event. The second part is to disable the key input event.

The first part is shown in FIG. 7. When the software starts, a routine is loaded and run in the background. The routine firstly creates an emulation flag and sets it to false. The routine get any key input signals from keyboard input buffer. If a key input signal is received, the routine checks whether a finger is touching the touchpad or the emulation flag is true. If either of the aforementioned conditions is true, the routine will check whether the key input signal is a key press signal or a key released signal. If the key input signal is a key press signal the routine sends a mouse button press command to the operating system and sets the emulation flag to true. If the key input signal is a key release signal the routine sends a mouse button release command to the operating system and sets the emulation flag to false. After the pointer input event is generated, the routine will go back to wait for and get another key input signal.

The second part, shown in FIG. 8, is used for filter the key input event. When the software starts a key-disable flag is created and set to false. The software inserts a key-disable callback into the operating system. It is a filter for all key input events. When the operating system gets a key input event it will pass the event to the callback and get back the key input event. When the key-disable callback receives key input event the routine will check whether a touch is on the touchpad or a key-disable flag is true. If the condition is not satisfied the key-input signal will be given back to the system as a normal key input event. If the aforementioned condition is satisfied the routine will check whether the key input event is a key press event or a key release event. If it is a key press event the routine will set the key-disable flag to true. If it is a key release event the routine will set the key-disable flag to false. Regardless of whether the key event is a press event or a release event the key event will be blocked by the routine.

Where in the foregoing description reference has been made to integers or elements having known equivalents then such are included as if individually set forth herein. Embodiments of the invention have been described, however it is understood that variations, improvement or modifications can take place without departure from the spirit of the invention or scope of the appended claims.

What is claimed is:

1. A method of emulating a pointing device button press in a computer having connected to it a keyboard having a plurality of keys and a pointing device, the method comprising:
detecting a key press input event from the keyboard, detecting a pointer input event from the pointing device;
determining whether the key press input event is detected during a time when the pointer input event is detected; and
performing a command emulating a pointing device button press when the key press input event is detected during the time when the pointer input event is detected.

2. The method of claim 1 wherein determining whether the key press input event is detected during the time when the pointer input event is detected comprises waiting until the key press input event is detected and when the key press input event is detected determining whether the pointer input event is detected.

3. The method of claim 1 wherein determining whether the key press input event is detected during the time when the pointer input event is detected includes determining whether an emulation flag is in a set state or a reset state, the emulation flag being in the set state during the time when the pointer input event is detected and in the reset state otherwise.

4. The method of claim 1 further comprising assigning a button press type to one or more keyboard keys, the button press type being one of a left button press, a right button press and a scroll press, evaluating the key press input event to determine the button press type, and wherein the command emulating a pointing device button press corresponds to the button press type.

5. The method of claim 1 wherein the pointing device is a touchpad.

6. A computer software product for use on a computer having connected to it a keyboard having a plurality of keys and a pointing device, the product comprising a computer readable medium in which computer instructions are stored, and when read by the computer cause the computer to:
detect a key press input event from the keyboard, detect a pointer input event from the pointing device, determine whether the key press input event is detected during a time when the pointer input event is detected; and
perform a command emulating a pointing device button press when the key press input event is detected during the time when the pointer input event is detected.

7. The product of claim 6 wherein determining whether the key press input event is detected during the time when the pointer input event is detected comprises waiting until the key press input event is detected and when the key press input event is detected determining whether the pointer input event is detected.

8. The product of claim 6 wherein determining whether the key press input event is detected during the time when the pointer input event is detected includes determining whether an emulation flag is in a set state or a reset state, the emulation flag being in the set state during the time when the pointer input event is detected and in the reset state otherwise.

9. The product of claim 6 in which the computer instructions when read by the computer cause the computer to further assigning a button press type to one or more keyboard keys, the button press type being one of a left button press, a right button press and a scroll press, evaluate the key press input event to determine the button press type, and wherein the command emulating a pointing device button press corresponds to the button press type.
